(19) United States
(12) Patent Application Publication
(10) Pub. No.: US 2004/0009422 A1
(43) Pub. Date: Jan. 15, 2004

(54) Transfer medium for toner image and method of use

(76) Inventor: David Charles Reynolds, Coppell, TX (US)

Correspondence Address: Monty L. Ross, Locke Liddell & Sapp LLP, 2200 Ross Avenue, Suite 2200, Dallas, TX, 75201-6776, US

(21) Appl. No.: 10/194,177

(22) Filed: Jul. 12, 2002

(51) Int. Cl. G03G 13/20

(52) U.S. Cl. 430/124; 428/202

(57) ABSTRACT

A transfer medium for receiving and subsequently applying an electrostatically deposited toner image onto a substrate, the medium having a polypropylene-containing, transparent film image carrier sheet with front and back surfaces and a smooth paper or film backing sheet adhered to the back surface of the image carrier sheet with a releasable adhesive. A method for using the subject transfer medium to transfer a toner image deposited onto the front surface of the polymeric film image carrier sheet to a substrate is also disclosed. Once the backing sheet is removed from the film image carrier sheet following image deposition, the transparency of the image carrier sheet facilitates registration of multiple layers on the substrate.

### BACKGROUND OF THE INVENTION

1. Field of the Invention

This invention relates to the transfer of monochrome and full color images from an image source to a substrate and, more particularly, to a medium and method for transferring electrostatically deposited toner images to a substrate using substantially transparent polypropylene film.

2. Description of Related Art

The need for a commercially satisfactory method and suitable materials for transferring electrostatically deposited color images such as photographs, pictures, graphics and the like onto fabrics and other substrates is well known. Inexpensive and reliable materials and methods are needed that will facilitate quick and accurate transfer of photocopied, full color images onto substrates that cannot be passed directly through a copy machine. While monochrome or color images are easily copied onto paper, they are not easily transferred to many substrates without loss of toner and resultant loss of color intensity. Also, because paper is substantially opaque, the use of paper as a transfer medium can make it difficult to overlay images with proper registration.

In order to avoid certain disadvantages associated with the use of paper as a transfer medium, some have attempted to transfer images using polymeric film. Although substantially transparent polymeric film and sheet materials such as vinyl acetate and various other polymers and copolymers have been widely used in safety glass and as transparencies for overhead projectors, many such films cannot be used reliably in conventional photocopy machines without jamming the machines, damaging the film or distorting the resultant image. These difficulties are believed to be due in part to effects of the heat that is applied to the polymeric film in order to fix the toner.

U.S. Pat. Nos. 5,842,096 and 6,198,898 B1 explicate several prior art references and technologies, and disclose the use of low-shrinkage polyethylene ester or polyimide film as a preferred image-carrying transfer medium. The transfer medium is placed against coated paper onto which a toner image has been electrostatically deposited using conventional monochrome or color photocopier technology, and the resultant “sandwich” is subjected to heat and pressure to transfer the toner image to the polyethylene ester or polyimide film. After peeling the paper away from the film, the image-carrying film is then placed in contact with a substrate and again subjected to heat and pressure, whereupon the toner image is transferred onto the substrate. Other polymeric films such as triacetate, Lexan® polycarbonate, Mylar® polyester and polyethylene terephthalate films are disclosed as being less effective than polyethylene ester films, particularly polyethylene naphthalate, for use in transferring electrostatically deposited toner images onto a substrate.

U.S. Pat. No. 5,842,096 and 6,198,898 B1 also report the development by Minolta of a method by which color pictures and illustrations are formed on a transparent plastic sheet made of an undisclosed material, then coated with a bonding agent and pressed against a substrate onto which the image is transferred and adhered by the bonding agent.

Notwithstanding the improvements disclosed in the prior art, a need remains for a transfer medium and method capable of efficiently and effectively transferring a monochrome or full color toner image to another substrate. This transfer is desirably achieved without color loss or distortion of the image. The transfer medium and method will desirably transfer substantially all toner particles to and from the transfer medium and will facilitate the subsequent registration of additional colors and images onto the transferred image.

### SUMMARY OF THE INVENTION

An image transfer medium and method of use are disclosed herein that will function reliably with conventional color copying machines, that is dimensionally stable when subjected to moderate heat and pressure, that will transfer essentially all of an electrostatically deposited toner image to a substrate, that will accurately reproduce colors as copied from an original source, and that will enable a user to accurately register overlays onto an image previously applied to a substrate.

According to one embodiment of the invention, a transfer medium for receiving and subsequently applying an electrostatically deposited toner image onto a substrate is disclosed. The medium preferably comprises a polypropylene-containing, transparent film with front and back surfaces and a paper backing sheet with a smooth, matte finish adhered to the back surface of the sheet with a releasable adhesive. Alternatively, a relatively transparent, dimensionally stable, acetate backing sheet can be used in place of an opaque paper backing sheet if desired, provided that the resultant transfer medium will still function acceptably in a photocopy machine. A method for using the subject transfer medium to transfer a toner image deposited onto the front surface of the polymeric sheet to a substrate is also disclosed. Once the backing sheet is removed from the polypropylene film following image deposition, the transparent film facilitates registration of multiple layers on the substrate.

According to another preferred embodiment of the invention, a transfer medium is provided that comprises a substantially transparent polymeric film, most preferably comprising polypropylene, having an opaque paper or clear film backing sheet releasably adhered to its back side. The image carrier film will most preferably have a thickness of about 1.2 mils, and will preferably have a thin coating of a well known, commercially available slip or release agent such as a fatty acid primary amide applied to its front and back surfaces. It should be understood, however, that the image carrier film can be thicker or thinner than 1.2 mils within the scope of the invention provided that it will otherwise function as described below. The backing sheet is preferably smooth, with a matte finish if an opaque paper, and is releasably attached to the back side of the film with any suitable adhesive that will release from the film following photocopying or other processing without leaving a residue on the film that will substantially obstruct its natural transparency.

According to another preferred embodiment of the invention, a method is disclosed for transferring an image from an image source to a substrate, the method most preferably comprising the steps of providing an image carrier sheet of polymeric film, most preferably comprising polypropylene, and a backing sheet of smooth paper having a matte finish or a clear acetate film; applying the backing sheet to the back side of the image carrier sheet using a releasable adhesive; copying an image, most preferably by electrostatic deposition of toner, from an original source onto the front face of the image carrier sheet; optionally, removing the backing sheet from the image carrier sheet; applying the image carrying surface of the image carrier sheet against the substrate intended to receive the image; subjecting the image carrier sheet and substrate to heat and pressure to transfer the image from the image carrier sheet to the substrate; and removing the image carrier sheet from the substrate, leaving the image fixed on the substrate. The success of this method necessarily depends upon the toner particles having a greater affinity for the substrate with which they are placed in contact than for the image carrier sheet, which is preferably substantially transparent polypropylene film.

According to another particularly preferred embodiment of the invention, additional images or pigment layers are subsequently overlaid onto an image already in place on a substrate. Because the image carrier sheet is preferably substantially transparent, a user can insure the proper registration of one image or layer over another to avoid blurring, etc., that might otherwise occur. In this method, where an opaque paper is used as the backing sheet, the backing sheet is desirably removed from the image carrier film prior to application of the image carrier film to the substrate to assist in registering the new layer or image over the old.

### BRIEF DESCRIPTION OF THE DRAWINGS

The transfer medium and method of the invention are further described and explained in relation to the following figures of the drawings wherein:

FIG. 1 is a front perspective view depicting an image disposed on the front face or surface of a substantially transparent polymeric image carrier sheet, most preferably polypropylene, which polymeric image carrier sheet also has a backing sheet releasably attached by an adhesive layer to its back surface, the backing sheet being partially peeled away from the back surface of the polymeric image carrier sheet;

FIG. 2 is a cross-sectional side elevation view taken along line 2-2 of FIG. 1;

FIG. 3 is a diagrammatic front elevation view showing a substantially transparent polymeric image carrier sheet with an electrostatically deposited image being placed downwardly onto a facing surface of a substrate onto which the image is to be transferred;

FIG. 4 is a diagrammatic front elevation view as in FIG. 3, but viewed after the image has been transferred from the polymeric image carrier sheet to the substrate and the polymeric image carrier sheet has been removed upwardly off the surface of the substrate; and

FIG. 5 is a block diagram depicting in simplified form a sequence of method steps that are preferably or optionally utilized in practicing the method of the invention.

Like reference numerals are used to indicate like parts in all figures of the drawings.

### DESCRIPTION OF THE PREFERRED EMBODIMENTS

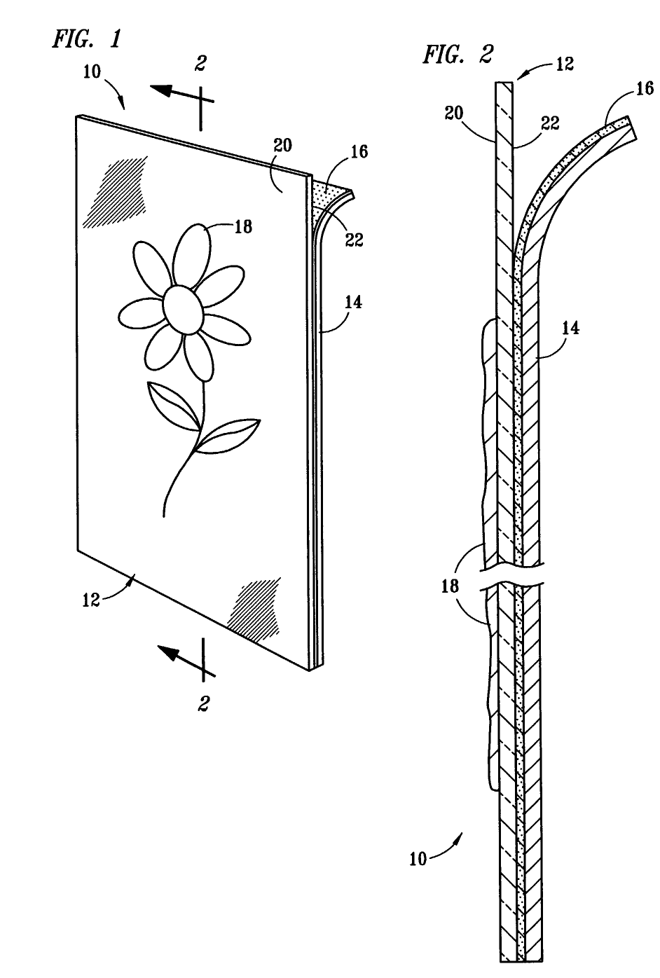

Referring to FIGS. 1 and 2, transfer medium 10 preferably comprises polymeric film image carrier sheet 12 having backing sheet 14 releasably adhered to back surface 22 by releasable adhesive 16 disposed between polymeric film image carrier sheet 12 and backing sheet 14. Image 18 is preferably carried temporarily on front surface 20 of polymeric film image carrier sheet 12, and preferably comprises a monochromatic or polychromatic array typically applied to front surface 20 as a plurality of electrostatically charged toner particles by a device such as an electronic photocopy machine. The toner particles are typically fused together and onto the image carrier surface by the application of heat prior to exiting a copier. It should be understood and appreciated that the thicknesses of polymeric film image carrier sheet 12, backing sheet 14, adhesive layer 16, and image 18 are exaggerated for illustrative purposes in FIGS. 1 and 2.

Polymeric film image carrier sheet 12 preferably comprises a substantially transparent polymer, copolymer or terpolymer consisting primarily of polypropylene and having a thickness that is most preferably about 1.2 mils, although thicker and thinner materials can be used effectively provided they will function as described herein. When made using polypropylene, polymeric film image carrier sheet 12 desirably demonstrates a combination of physical properties that allow it to function as a temporary carrier for image 18 and enable polymeric film image carrier sheet 12 to be processed reliably through conventional photocopy machines while maintaining a degree of dimensionally stability that is needed to avoid image distortion. According to another particularly preferred embodiment of the invention, the front and back surfaces of polymeric film image carrier sheet 12 have a thin coating of a slip or release agent, preferably a fatty acid primary amide, that will reduce friction and improve the processability of the polymeric film; reduce the tendency of polymeric film sheets to stick to each other; and facilitate the release of image 18 from front face 20 during application of image 18 to another substrate. Commercially available slip agents useful in film 12 of transfer medium 10 of the invention include, for example, stearamide, oleamide and erucamide.

Backing sheet 14 is preferably an opaque paper comprising a smooth, non-glossy surface that is substantially coextensive with polymeric film image carrier sheet 12 and, when placed in facing engagement with back surface 22 of polymeric film image carrier sheet 12 with a thin layer of a suitable adhesive 16 disposed therebetween, will releasably adhere to back surface 22, even when the composite transfer medium 10 thus assembled is passed through a conventional monochrome or color photocopier. Alternatively, backing sheet 14 can comprise a substantially clear or transparent polymeric film, such as acetate film, provided that the transparent film is capable of otherwise functioning in the same manner as an opaque paper backing sheet 14 in achieving the advantages and benefits of the invention.

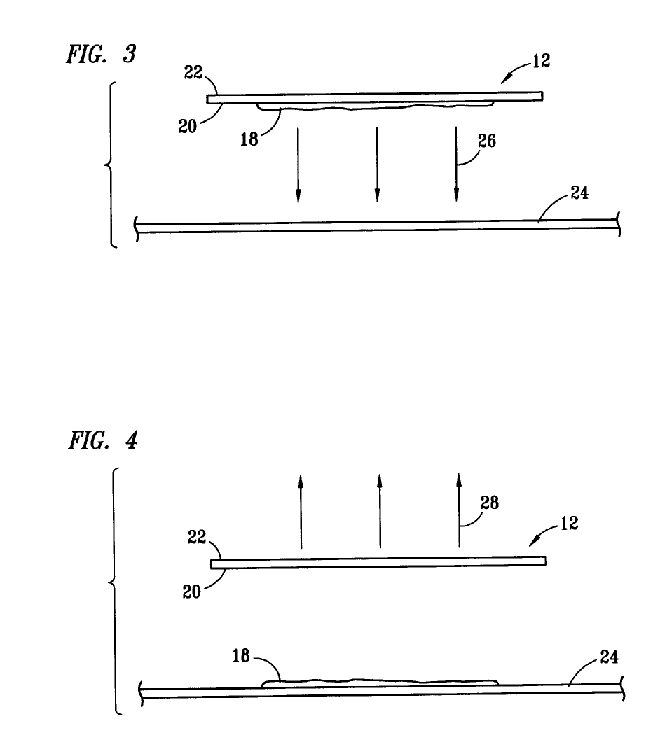

Adhesive layer 16 can be continuously or discontinuously applied across either of the facing surfaces of polymeric film image carrier sheet 12 and paper sheet 14, and can be selected from any of what are believed to be many commercially available pressure-sensitive adhesives capable of releasably securing backing sheet 14 to polymeric film image carrier sheet 12 so that backing sheet 14 can be peeled away from polymeric film image carrier sheet 12 prior to application of image 18 to another substrate as discussed below in relation to FIGS. 3 and 4. Adhesive layer 16 will desirably have a greater affinity for backing sheet 14 than for polymeric film image carrier sheet 12 so that most if not all of adhesive layer 16 will adhere to backing sheet 14 when backing sheet 14 is peeled away from polymeric film image carrier sheet 12 as shown in FIGS. 1 and 2 following deposition of image 18 onto film 12.

The provision and use of a transfer medium 10 comprising a paper or acetate backing sheet releasably attached to the back side of a polymeric film image-carrier sheet, most preferably comprising polypropylene, is believed to be a significant feature of the invention for the reason that it enables the image to be deposited directly onto the image carrier film while reducing the likelihood of distortion, damage or jamming as the image carrier film passes through a conventional copy machine. By depositing image 18 directly onto a polymeric film image carrier sheet 12, the image is transferred only once, as compared to twice in prior art processes where an image is first photocopied onto paper, then transferred to film and subsequently transferred again to a substrate as disclosed, for example, in U.S. Pat. No. 5,842,096. By removing backing sheet 14 from back surface 22 of polymeric film image carrier sheet 12 prior to transferring image 18 to another substrate, where backing sheet 14 is made of opaque paper, one is also able to view the substrate through sheet 12 while transferring image 18 from sheet 12 to the substrate. This feature is particularly important when registering overlays as discussed later in relation to the method of the invention.

Referring to FIG. 3, image 18 is desirably applied to substrate 24 by aligning front surface 20 of polymeric film image carrier sheet 12 with the facing surface of substrate 24 and thereafter causing image 18 to be pressed tightly into engagement with substrate 24 as indicated by arrows 26. Heat and pressure are then desirably applied to polymeric film image carrier sheet 12 and substrate 24 so that image 18 will be transferred to substrate 24 as shown in FIG. 4. Although the means for applying heat and pressure to polymeric film image carrier sheet 12 and substrate 24 are not shown in the drawings, it will be appreciated from reference to the prior art disclosed above that conventional apparatus comprising heated rollers or other similarly effective conventional means can be used for this purpose and to effect this result. The amount of pressure and heat required to effect the transfer of image 18 from the polymeric film image carrier sheet 12 to substrate 24 can vary according to the particular materials and thicknesses involved, but should not be so great as to destructively deform film sheet 12, image 18 or substrate 24.

Referring to FIG. 4, following the transfer of image 18 from the carrier, polymeric film image carrier sheet 12, to substrate 24, polymeric film image carrier sheet 12 is desirably lifted away from substrate 24, leaving image 18 bonded to substrate 24. It is important for this purpose that image 18 have a greater affinity for substrate 24 than for surface 20 of polymeric film image carrier sheet 12 when subjected to heat and pressure. It is also believed that coating surface 20 of polymeric film image carrier sheet 12 with a minor effective amount of a release agent known to be effective for use with such polymers prior to depositing image 18 on film 12 will promote the subsequent transfer of substantially all the toner material forming image 18 from surface 20 to substrate 24. Substantially complete transfer of all toner material is believed to enhance the quality of the resultant image when applied to substrate 24.

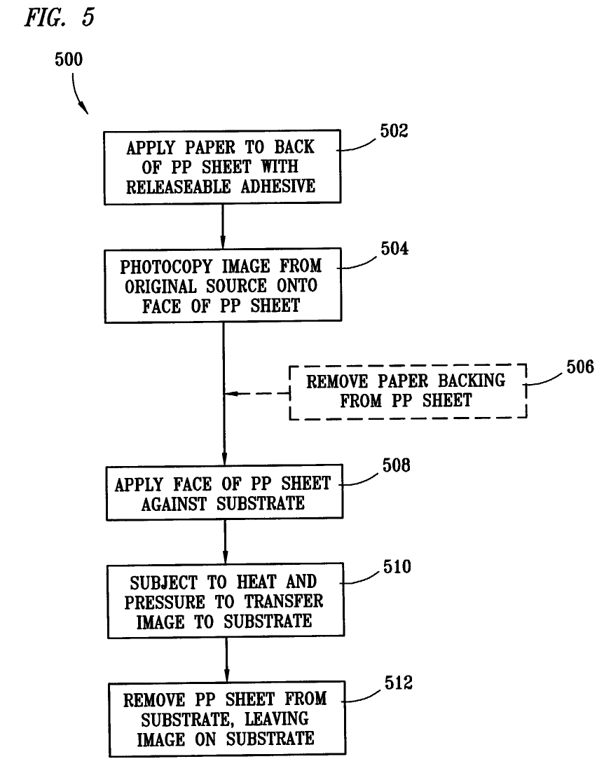

One particularly preferred embodiment of the method of the invention is further described and explained in relation to FIG. 5. Referring to FIG. 5, method 500 preferably comprises steps including step 502 of applying a paper or film backing to the back of a transparent polypropylene film sheet with a releasable adhesive between them; step 504 of photocopying an image from an original source onto the face of the polypropylene film sheet; step 508 of applying the face of the polypropylene film sheet bearing the photocopied image against another substrate; step 510 of subjecting the polypropylene sheet and substrate to heat and pressure sufficient to cause the image to release from the polypropylene film sheet and attach to the other substrate; and step 512 of removing the polypropylene film sheet from the substrate, leaving the image on the substrate. The prior step of providing the polypropylene film sheet, paper backing and releasable adhesive will be apparent to those of skill in the art upon reading this disclosure. In step 510, heat and pressure can be applied using conventional, commercially available rollers well known to those of ordinary skill in the art.

If only a single image layer is to be applied to the substrate, it is desirable but not required that the opaque paper backing sheet, if paper is used, be removed from the polypropylene film image carrier sheet prior to transferring the image to the substrate. On the other hand, if a subsequent layer or layers of pigment or other material are overlaid onto a first image on the substrate, prior removal of a paper backing sheet from the polypropylene sheet is desirable to permit viewing of the first image through the sheet to assist in obtaining proper registration of the subsequent layer with respect to the image or layer that was previously transferred. Where a clear film backing sheet is also used, removal of the backing sheet may not be necessary for registering successive layers over the first.

The application of an image comprising multiple layers or overlays of pigments or other materials onto a substrate to achieve a particularly preferred visual effect desirably involves the repetitive application of steps described above in relation to FIG. 5 and is understood and intended to fall within the scope of the present invention.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A transfer medium useful for receiving, carrying and subsequently transferring a toner image onto a substrate, the medium comprising a substantially transparent, polypropylene-containing film image carrier sheet with front and back surfaces and a backing sheet releasably attached to the back surface of the image carrier sheet with a releasable adhesive therebetween.

2. The transfer medium of claim 1 wherein the image carrier sheet is made of polypropylene film.

3. The transfer medium of claim 1 wherein the image carrier sheet has a thickness of about 1.2 mils.

4. The transfer medium of claim 1 wherein the toner image is electrostatically deposited on the image carrier sheet.

5. The transfer medium of claim 1 wherein the toner image is a color image.

6. The transfer medium of claim 1 wherein the surfaces of the image carrier sheet are coated with a slip agent.

7. The transfer medium of claim 6 wherein the slip agent is a fatty acid primary amide.

8. The transfer medium of claim 7 wherein the slip agent is selected from the group consisting of stearamide, oleamide and erucamide.

9. The transfer medium of claim 1 wherein the backing sheet is made of paper.

10. The transfer medium of claim 9 wherein the paper has a matte finish.

11. The transfer medium of claim 1 wherein the backing sheet is made of substantially transparent polymeric film.

12. The transfer medium of claim 11 wherein the backing sheet is acetate film.

13. The transfer medium of claim 1 wherein the adhesive is a pressure sensitive adhesive.

14. The transfer medium of claim 1 wherein the adhesive is applied in a substantially continuous layer.

15. A method for receiving and carrying an electrostatically deposited toner image on a transfer medium and for transferring the toner image to another substrate, the method comprising the steps of:
providing a transfer medium comprising a substantially transparent polypropylene-containing film image carrier sheet with front and back surfaces and a smooth backing sheet releasably attached to the back surface;
electrostatically depositing a toner image copied from an original source onto the front surface of the image carrier sheet;
positioning the front surface of the image carrier sheet with the toner image in facing relation to the substrate and pressing the image carrier sheet and toner image into engagement with the substrate;
subjecting the image carrier sheet and substrate to heat and pressure while engaged, the heat and pressure being sufficient to cause the image to release from the image sheet and attach to the substrate; and
removing the image carrier sheet from the substrate.

16. The method of claim 15 wherein the image carrier sheet is made of polypropylene.

17. The method of claim 15 wherein the image carrier sheet has a thickness of about 1.2 mils.

18. The method of claim 15 wherein the toner image is deposited on the transfer medium by a photocopy machine.

19. The method of claim 15 wherein the toner image is a color image.

20. The method of claim 15 wherein the backing sheet is removed from the back surface of the image carrier sheet before engaging the image carrier sheet with the substrate.

21. The method of claim 15 wherein the backing sheet comprises paper.

22. The method of claim 15 wherein the backing sheet comprises substantially transparent polymeric film.

23. The method of claim 22 wherein the backing sheet is acetate film.

24. The method of claim 15 wherein the heat and pressure are applied by passing the image carrier sheet and substrate between rollers.

25. The method of claim 15 comprising the additional steps of providing a second transfer medium and using it to register and apply a second toner image over the toner image on the substrate.

26. The method of claim 25 wherein the second toner image comprises a pigment overlay.
